(19) United States
(12) Patent Application Publication
(10) Pub. No.: US 2025/0296095 A1
(43) Pub. Date: Sep. 25, 2025

(54) WATER OUTLET DEVICE CAPABLE OF ADJUSTING SPRINKLER PATTERNS

(71) Applicant: Cheng-An WANG, Taichung City (TW)

(72) Inventor: Cheng-An WANG, Taichung City (TW)

(21) Appl. No.: 18/634,345

(22) Filed: Apr. 12, 2024

(30) Foreign Application Priority Data
Mar. 19, 2024 (TW) 113110116

(51) Int. Cl. B05B 1/16

(52) U.S. Cl. CPC B05B 1/1681

(57) ABSTRACT

Disclosed is a water outlet device capable of adjusting sprinkler patterns, including a connecting member having an interior forming a water inlet pipe, a water outlet member sleeved on the connecting member forming a first and second water outlet structure, and a blocking structure. The water inlet pipe is axially aligned and communicated with either the first or second water outlet structure to allow water to pass therethrough to form different sprinkler patterns. The blocking structure is connected to the water inlet pipe and is extended with a passage communicating with the pipe. The blocking structure forms two blocking segments with the passage located between the two blocking segments, and elastically abuts the water outlet member. When the sprinkling pattern changes, the water flow is prevented from flowing laterally into the connecting member, thereby improving the water utilization efficiency for sprinkling.

### CROSS-REFERENCE TO RELATED APPLICATIONS

Not applicable.

### BACKGROUND OF THE INVENTION

The present invention relates to a component of a sprinkler capable of adjusting sprinkler patterns, in particular to a water outlet device capable of adjusting sprinkler patterns.

In a sprinkler capable of adjusting sprinkler patterns, a water inlet pipe is formed inside the main body thereof, and a water outlet disk is rotatably mounted at the front end of the main body with multiple water outlet structures. By rotating the water outlet disk, the water inlet pipe is axially aligned and communicated with a selected water outlet structure, allowing the sprinkler pattern to be adjusted.

Under the premise of not interrupting the sprinkler, by rotating the water outlet disk, the axially aligned water outlet structure gradually shifts laterally away from the water inlet pipe. As a result, some of the water from the water inlet pipe flows laterally into the main body instead of being sprayed out through the water outlet structure. As the rotation continues, the aligned hole area between the water outlet structure and the water inlet pipe decreases, resulting in an increase in the amount of unsprayed water entering the main body. Until the next adjacent water outlet structure is completely aligned with the water inlet pipe, the problem of water entering the main body instead of being sprayed out can be solved.

Due to this design, some of the water entering the main body will flow out through other water outlet structures that are not aligned with the water inlet pipe, resulting in water accumulation problems at the sprinkler installation site.

### SUMMARY OF THE INVENTION

The main purpose of the present invention is to provide a water outlet device capable of adjusting sprinkler patterns. In order to achieve the aforementioned purpose, the present invention adopts the following technical solution:

A water outlet device capable of adjusting sprinkler patterns including a shell-shaped connecting member having a front end forming an annular mounting head and an interior shaping a water inlet pipe. An imaginary axial line is defined passing through the radial center of the mounting head and extending along the axial direction thereof, where the axial direction of the water inlet pipe deviates from the axial line.

A disk-shaped water outlet member has a center plate and an annular ring. The center plate is connected to the inner annular edge of the annular ring, the annular ring being sleeved on the mounting head to allow the water outlet member to rotate relative to the connecting member, and the center plate forming a first water outlet structure and a second water outlet structure. An imaginary circular line is defined with the axial line passing through the center of the circular line. The first water outlet structure and the second water outlet structure are spaced apart along the circular line, and the water inlet pipe is axially aligned and communicated with either the first water outlet structure or the second water outlet structure. The first water outlet structure and the second water outlet structure each have at least one water outlet hole to allow water to pass through the first water outlet structure or the second water outlet structure to form different sprinkler patterns.

A blocking structure is connected to the water inlet pipe, the blocking structure being extended with a passage communicating with the water inlet pipe, the blocking structure forming two blocking segments and the passage being located between the two blocking segments, the two blocking segments and the passage being configured along the circumferential direction centered around the axial line. The blocking structure elastically abuts against the water outlet member.

The main effect and advantage of the present invention is that during the operation of adjusting the sprinkler pattern, the water flow is blocked by the respective blocking segments and prevented from flowing laterally into the interior of the shell-shaped connecting member, thereby improving the water utilization efficiency for sprinkling and avoiding water accumulation problems at the sprinkler installation site.

### BRIEF DESCRIPTION OF DRAWINGS

FIG. 1 is a perspective view of a preferred embodiment of the present invention.

FIG. 2 is a top view of a preferred embodiment of the present invention.

FIG. 3 is an exploded perspective view of a preferred embodiment of the present invention.

FIG. 4 is a top view of a preferred embodiment of the present invention with the water outlet member removed.

FIG. 5 is a sectional view of a preferred embodiment of the present invention.

FIG. 6 is a sectional view taken along line 6-6 of FIG. 5.

FIG. 7 is a sectional view of a preferred embodiment of the present invention in an operating state (1).

FIG. 8 is a sectional view of a preferred embodiment of the present invention in an operating state (2).

FIG. 9 is a sectional view of a preferred embodiment of the present invention in an operating state (3).

### DETAILED DESCRIPTION OF THE INVENTION

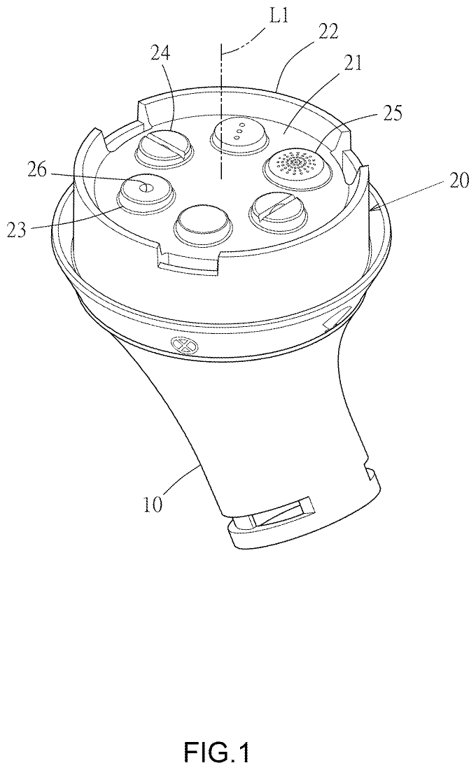

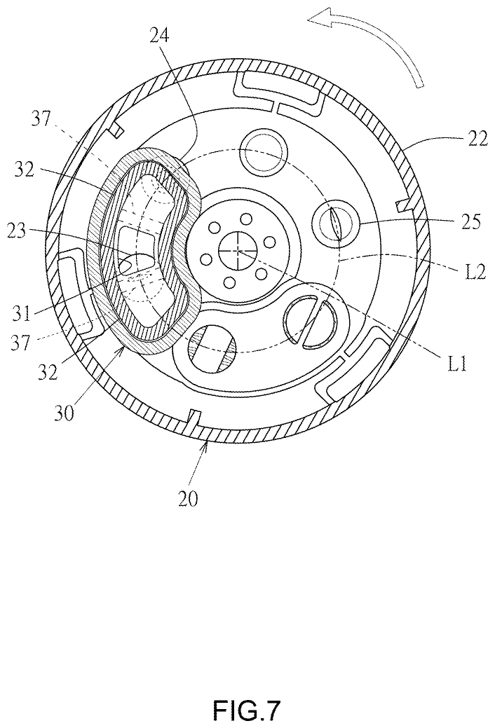

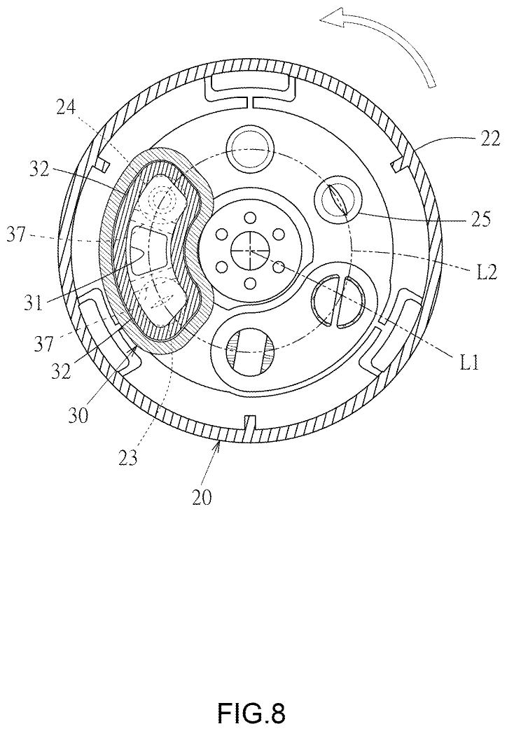

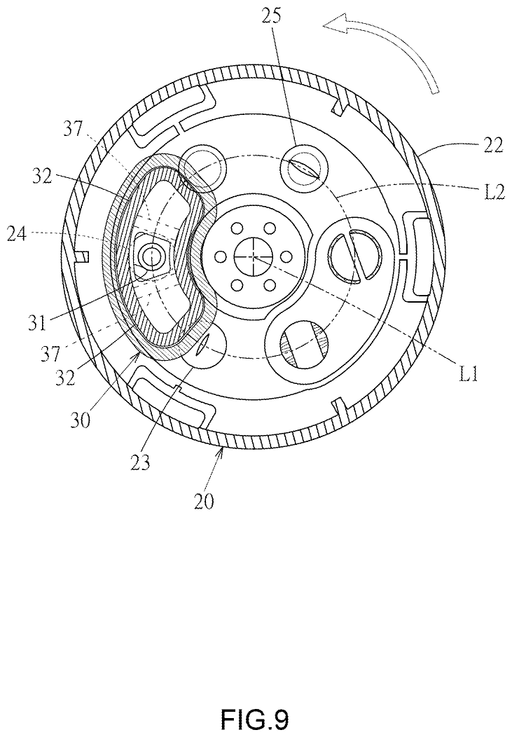

As shown in FIGS. 1 to 9, a preferred embodiment of a water outlet device capable of adjusting sprinkler patterns comprises a shell-shaped connecting member 10, a disk-shaped water outlet member 20, and a blocking structure 30. The connecting member 10 is used to form a part of the main body of a sprinkler, which may be a mobile sprinkler gun or a fixed sprinkler base. The front end of the connecting member 10 forms an annular mounting head 12, and the interior of the connecting member 10 forms a water inlet pipe 14. One end of the water inlet pipe 14 communicates with a flow channel inside the main body for guiding the water flow, allowing water to flow out through the water inlet pipe 14. An imaginary axial line L1 is defined passing through the radial center of the mounting head 12 and extending along the axial direction of the mounting head 12, where the axial direction of the water inlet pipe 14 deviates from the axial line L1.

The water outlet member 20 comprises a center plate 21 and an annular ring 22, wherein the center plate 21 is connected to the inner annular edge of the annular ring 22, and the annular ring 22 is sleeved on the mounting head 12, allowing the water outlet member 20 to rotate relative to the connecting member 10 with the axial line L1 as the center. The center plate 21 forms a first water outlet structure 23, a second water outlet structure 24, and multiple third water outlet structures 25. An imaginary circular line L2 is defined with the axial line L1 passing through the center of the circular line L2. The first water outlet structure 23, the second water outlet structure 24, and the third water outlet structures 25 are spaced apart along the circular line L2, where the first water outlet structure 23 and the second water outlet structure 24 are arranged adjacent to each other along the circumferential direction of the circular line L2.

The third water outlet structures 25 are selectively arranged based on the radial dimension of the center plate 21, and the number of the third water outlet structures 25 may be increased or decreased as needed, not limited to the examples illustrated in the preferred embodiment.

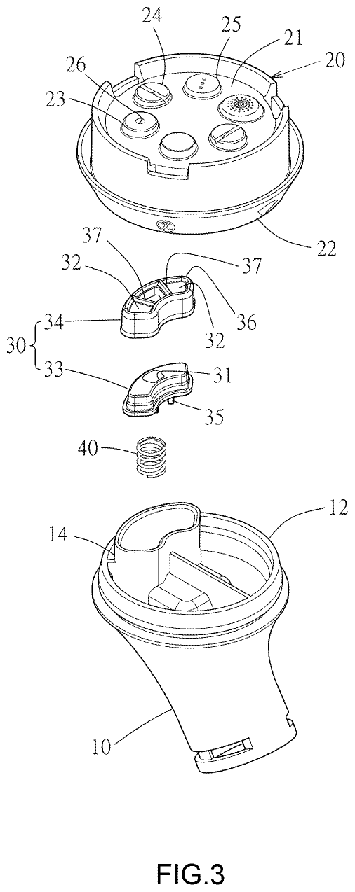

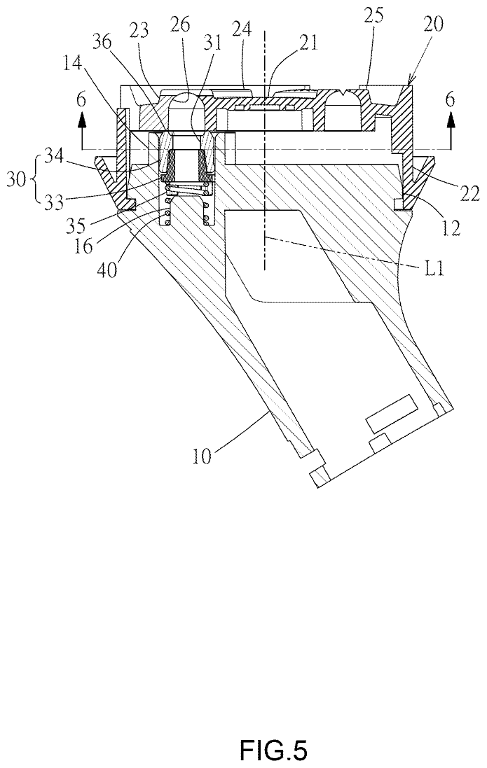

The water inlet pipe 14 is selectively axially aligned and communicated with either the first water outlet structure 23, the second water outlet structure 24, or any of the third water outlet structures 25. FIGS. 3 and 5 show the water inlet pipe 14 axially aligned and communicated with the first water outlet structure 23. As the water outlet member 20 rotates, the water inlet pipe 14 can be sequentially changed to be axially aligned and communicated with the second water outlet structure 24 or any of the third water outlet structures 25. Thus, the water passes through the water inlet pipe 14 and selectively passes through the first water outlet structure 23, the second water outlet structure 24, or any of the third water outlet structures 25 for external spraying. The first water outlet structure 23, the second water outlet structure 24, and each of the third water outlet structures 25 have one to several water outlet holes 26 with different numbers, shapes, or hole diameters, thereby allowing water to pass through the first water outlet structure 23, the second water outlet structure 24, or any of the third water outlet structures 25 to form different sprinkler patterns.

The water outlet member 20 is a known structure familiar to those skilled in the art to which the present invention pertains.

The blocking structure 30 is connected to the water inlet pipe 14, and the blocking structure 30 is extended with a passage 31 communicating with the water inlet pipe 14. The blocking structure 30 forms two blocking segments 32, and the passage 31 is located between the two blocking segments 32. The two blocking segments 32 and the passage 31 are configured along the circumferential direction centered around the axial line L1, and the blocking structure 30 elastically abuts against the water outlet member 20.

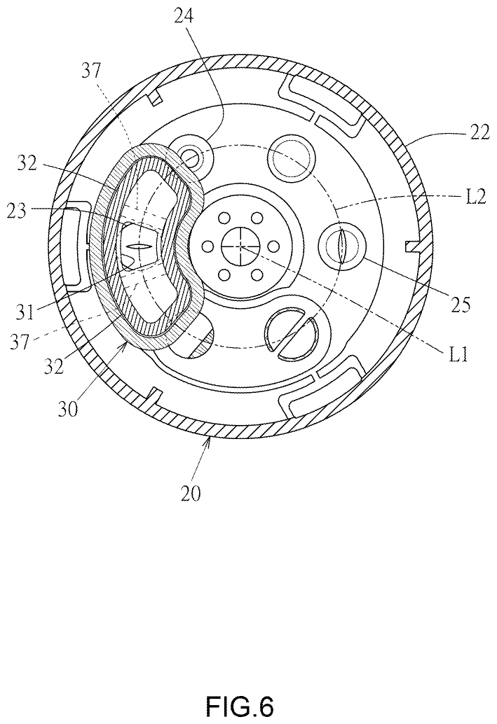

The process of adjusting the sprinkler pattern is illustrated by way of example in FIGS. 6 to 9. By rotating the water outlet member 20, the axial direction of the first water outlet structure 23 gradually deviates from the center of the passage 31, while the axial direction of the second water outlet structure 24 gradually approaches the center of the passage 31, until the axial direction of the second water outlet structure 24 is aligned with the center of the passage 31, thereby completing the operation of adjusting the sprinkler pattern. During the operation, the first water outlet structure 23 is gradually blocked by the blocking segment 32 on one side of the passage 31, while the second water outlet structure 24 gradually approaches and communicates with the passage 31, with the area of the second water outlet structure 24 blocked by the blocking segment 32 on the other side of the passage 31 gradually decreasing. Thus, during the operation of rotating the water outlet member 20 to adjust the sprinkler pattern, the water flow passing through the passage 31 is blocked by the two blocking segments 32 and prevented from flowing laterally into the interior of the shell-shaped connecting member 10 and from flowing outward through the water outlet structures not aligned with the passage 31, such as the first water outlet structure 23, the second water outlet structure 24, or any of the third water outlet structures 25, thereby improving the water utilization efficiency for sprinkling and avoiding water accumulation problems at the sprinkler installation site.

The blocking structure 30 forms a circular sector configuration, with the axial line L1 passing through the center of the blocking structure 30.

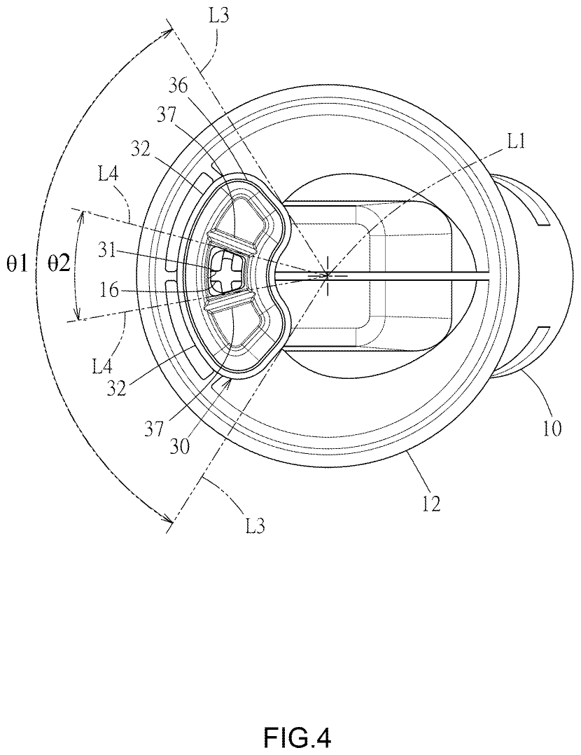

As shown in FIG. 4, two imaginary first lines L3 are defined, each being perpendicular to the axial line L1 and each passing through the axial line L1 and the end of each blocking segment 32 furthest from the passage 31 along the arc direction of the blocking structure 30, the two first lines L3 forming a first angle θ1. Two imaginary second lines L4 are defined, each perpendicular to the axial line L1 and each tangent to the radial outer periphery of the passage 31 on two sides, the two second lines L4 forming a second angle θ2.

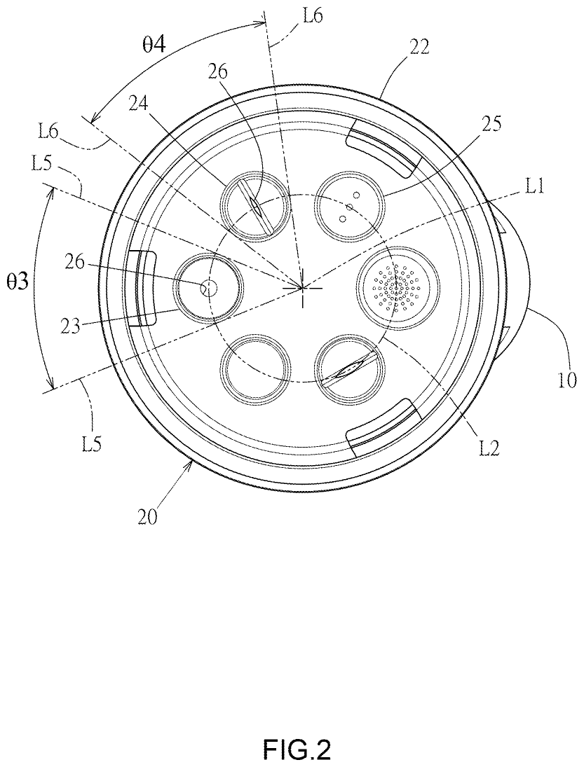

As shown in FIG. 2, two imaginary third lines L5 are defined, each being perpendicular to the axial line L1 and each being tangent to the radial outer periphery of the first water outlet structure 23 on two sides, the two third lines L5 forming a third angle θ3. Two imaginary fourth lines L6 are defined, each being perpendicular to the axial line L1 and each being tangent to the radial outer periphery of the second water outlet structure 24 on two sides, the two fourth lines L6 forming a fourth angle θ4.

Wherein, the first angle θ1 is equal to or greater than the sum of the second angle θ2, the third angle θ3, and the fourth angle θ4.

The water inlet pipe 14 is sleeved on the outer circumference of the blocking structure 30 in the radial direction. A holding spring 40 is provided inside the water inlet pipe 14, and the blocking structure 30 is disposed between the holding spring 40 and the water outlet member 20. One end of the holding spring 40 abuts against the connecting member 10, while the other end abuts against the blocking structure 30, thereby providing elasticity to ensure that the blocking structure 30 remains tightly abutted against the water outlet member 20.

The blocking structure 30 comprises a positioning component 33 and a water-sealing component 34, wherein the holding spring 40 abuts against the positioning component 33. The positioning component 33 comprises multiple projecting rods 35, which are spaced apart around the outer periphery of the holding spring 40 in the radial direction for positioning the holding spring 40. The water-sealing component 34 is sleeved over the positioning component 33 and is positioned on the side of the positioning component 33 facing the water outlet member 20. The water-sealing component 34 forms the two blocking segments 32, and the passage 31 extends through the positioning component 33 and the water-sealing component 34. The water-sealing component 34 is made of an elastic material.

The connecting member 10 forms a shaft 16, and the holding spring 40 is axially sleeved over the shaft 16.

On the side facing the water outlet member 20, the blocking structure 30 forms a first sealing strip 36 and two second sealing strips 37. The elastic first sealing strip 36 and the two second sealing strips 37 elastically abut against the water outlet member 20. The annular first sealing strip 36 is adjacent to the edge of the blocking structure 30, and the two second sealing strips 37 are adjacent to the two sides of the passage 31, respectively, with each second sealing strip 37 being connected to the first sealing strip 36. The first sealing strip 36 and the two second sealing strips 37 are integrally formed with the water-sealing component 34.

When the passage 31 is axially aligned and communicated with the first water outlet structure 23, the second water outlet structure 24, or any of the third water outlet structures 25, the two second sealing strips 37 together with the first sealing strip 36 between the two second sealing strips 37 can enhance the prevention of lateral leakage of water passing through the passage 31 into the first water outlet structure 23, the second water outlet structure 24, or any of the third water outlet structures 25. In addition, during the operation of rotating the water outlet member 20 to adjust the sprinkler pattern, the first sealing strip 36 formed at the two blocking segments 32 can enhance the prevention of water laterally flowing into the connecting member 10.

1. A water outlet device capable of adjusting sprinkler patterns, comprising:
a shell-shaped connecting member having a front end forming an annular mounting head and an interior shaping a water inlet pipe; an imaginary axial line is defined passing through the radial center of the mounting head and extending along the axial direction thereof, where the axial direction of the water inlet pipe deviates from the axial line;
a disk-shaped water outlet member having a center plate and an annular ring, the center plate being connected to the inner annular edge of the annular ring, the annular ring being sleeved on the mounting head to allow the water outlet member to rotate relative to the connecting member, and the center plate forming a first water outlet structure and a second water outlet structure; an imaginary circular line is defined with the axial line passing through the center of the circular line, the first water outlet structure and the second water outlet structure are spaced apart along the circular line, and the water inlet pipe is axially aligned and communicated with either the first water outlet structure or the second water outlet structure; the first water outlet structure and the second water outlet structure each having at least one water outlet hole to allow water to pass through the first water outlet structure or the second water outlet structure to form different sprinkler patterns; and
a blocking structure connected to the water inlet pipe, the blocking structure being extended with a passage communicating with the water inlet pipe, the blocking structure forming two blocking segments and the passage being located between the two blocking segments, the two blocking segments and the passage being configured along the circumferential direction centered around the axial line, and the blocking structure elastically abutting against the water outlet member.

2. The water outlet device capable of adjusting sprinkler patterns according to claim 1, wherein the blocking structure forms a circular sector configuration, with the axial line passing through the center of the blocking structure.

3. The water outlet device capable of adjusting sprinkler patterns according to claim 2, wherein:
two imaginary first lines are defined, each being perpendicular to the axial line and each passing through the axial line and the end of each blocking segment furthest from the passage along the arc direction of the blocking structure, the two first lines forming a first angle;
two imaginary second lines are defined, each being perpendicular to the axial line and each being tangent to the radial outer periphery of the passage on two sides, the two second lines forming a second angle;
two imaginary third lines are defined, each being perpendicular to the axial line and each being tangent to the radial outer periphery of the first water outlet structure on two sides, the two third lines forming a third angle; and
two imaginary fourth lines are defined, each being perpendicular to the axial line and each being tangent to the radial outer periphery of the second water outlet structure on two sides, the two fourth lines forming a fourth angle;
wherein, the first angle is equal to or greater than the sum of the second angle, the third angle, and the fourth angle.

4. The water outlet device capable of adjusting sprinkler patterns according to claim 1, wherein the water inlet pipe is sleeved on the radial outer periphery of the blocking structure in the radial direction, a holding spring is provided inside the water inlet pipe, the blocking structure is positioned between the holding spring and the water outlet member, and one end of the holding spring abuts against the connecting member while the other end abuts against the blocking structure.

5. The water outlet device capable of adjusting sprinkler patterns according to claim 1, wherein on the side facing the water outlet member, the blocking structure forms a first sealing strip and two second sealing strips, the elastic first sealing strip and the two second sealing strips elastically abut against the water outlet member, the annular first sealing strip is adjacent to the edge of the blocking structure, and the two second sealing strips are adjacent to the two sides of the passage, respectively, with each second sealing strip being connected to the first sealing strip.
